(19) United States
(12) Patent Application Publication
(10) Pub. No.: US 2009/0299612 A1
(43) Pub. Date: Dec. 3, 2009

(54) METHOD OF IDENTIFYING ENGINE GAS COMPOSITION

(75) Inventors: Anthony J. Truscott, West Sussex (GB); Richard Charles E. Cornwell, Henfield (GB); Tomasz M. Salamon, Worthing (GB); Martin Egginton, Aoba-ku (JP)

Correspondence Address: OSHA LIANG L.L.P., TWO HOUSTON CENTER, 909 FANNIN, SUITE 3500, HOUSTON, TX, 77010, US

(73) Assignee: RICARDO UK LIMITED, West Sussex (GB)

(21) Appl. No.: 12/162,324

(22) PCT Filed: Jan. 26, 2007
(86) PCT No.: PCT/GB2007/000274

§ 371 Date: Jan. 21, 2009

(30) Foreign Application Priority Data
Jan. 27, 2006 (GB) 0601727.1

(51) Int. Cl. F02D 41/00; G01M 15/08

(52) U.S. Cl. 701/108; 73/114.16

(57) ABSTRACT

A method and apparatus of identifying engine gas composition in an engine cylinder comprise obtaining a measure of cylinder pressure from a cylinder pressure sensor, deriving the polytropic index from said measure and obtaining a measure of the quantity of an engine gas component therefrom.

The invention relates to a method of identifying engine gas composition.

The demands for lower fuel consumption and tough emissions reduction targets has led to the requirement of after treatment systems. However, the systems required for diesel engines are costly and therefore in order to delay their introduction, there is much focus on finding new ways of reducing engine-out emissions. It is well established that combustion duration within a cylinder of an engine correlates significantly with the charge content of said cylinder. EGR (exhaust gas recirculation) is conventionally employed to control the temperature and rate of combustion in order to achieve non-conventional combustion modes.

In general, the higher the amount of inert gas (EGR), the slower and more controlled the rate of combustion and therefore the less NOx out and the cooler the engine. However, the distribution of EGR, air and O₂ between individual engine cylinders is becoming more significant. Taking the example of a diesel engine, all cylinders would normally receive the same amount of fuel (adversely reducing torque) in order to control the smoke output, but the overall performance of an engine is often limited to the ‘culprit’ cylinder that contains either the least or most of one of the species for the required transient or steady-state conditions.

Because of recent developments in the individual cylinder control of fuelling and valve actuation for example by an ECU (engine control unit) the estimation of the composition of the gas within each cylinder is becoming more of a practical requirement.

One known approach is to obtain the rate of heat release from cylinder pressure signals and use this to estimate the AFR (Air/Fuel Ratio) and EGR through empirical look-up tables. However, this is prone to error at light loads or with more complex multi-injection fuelling systems.

Other known approaches are based on individual cylinder pressure sensor data but suffer from problems in obtaining sufficiently accurate data for passing to the ECU for engine control purposes. In US648694, cylinder pressure sensor drift is corrected according to detected manifold pressure. This is a well known practice on test beds, however is not so ideal in real-world engines, such as those in production vehicles, where cylinder to cylinder interaction and signal noise will exist. This is due to lower quality sensors and the need for transient control. WO02/095191 estimates polytropic index based on three pressure sensor samples which suffers from the problem of inaccuracy and noise. For cylinder charge estimation, JP2001-15293 describes using cylinder pressure to estimate the total gas composition within a cylinder, however it does not consider the individual species. The air or O₂ content is important for controlling smoke emissions on a diesel engine. U.S. Pat. No. 5,611,311 discloses TDC (Top Dead Centre) estimation and correction where the cylinder pressure is observed at maximum in over-ran (zero-fuelling) without considering thermal loss in the system which can lead to inaccuracies. This is particularly relevant for strategies based on cylinder pressure feedback control that rely on calculations involving both instantaneous pressure and volume.

The invention is set out in the claims.

Embodiments of the invention will now be described, with reference to the drawings, of which:

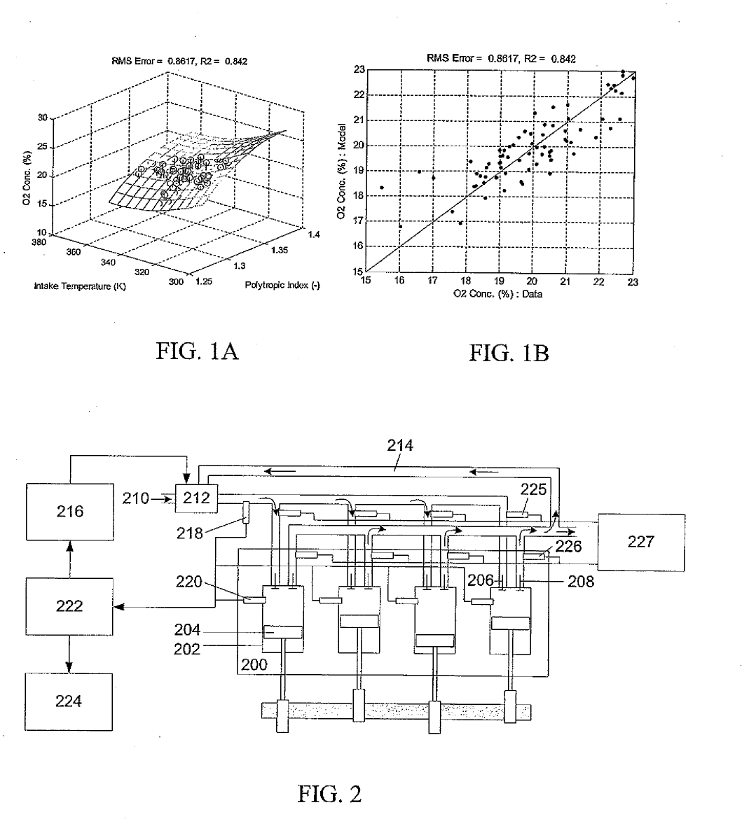

FIG. 1A is a plot showing steady-state test-bed results where O2 charge concentration is plotted against polytropic index and intake manifold temperature;

FIG. 1B shows a plot of estimated O₂ concentration, obtained from the calibration map in FIG. 1A, against corresponding testbed results for validation purposes;

FIG. 2 shows a schematic diagram of a test-bed implementation for obtaining the concentration functions for all species present;

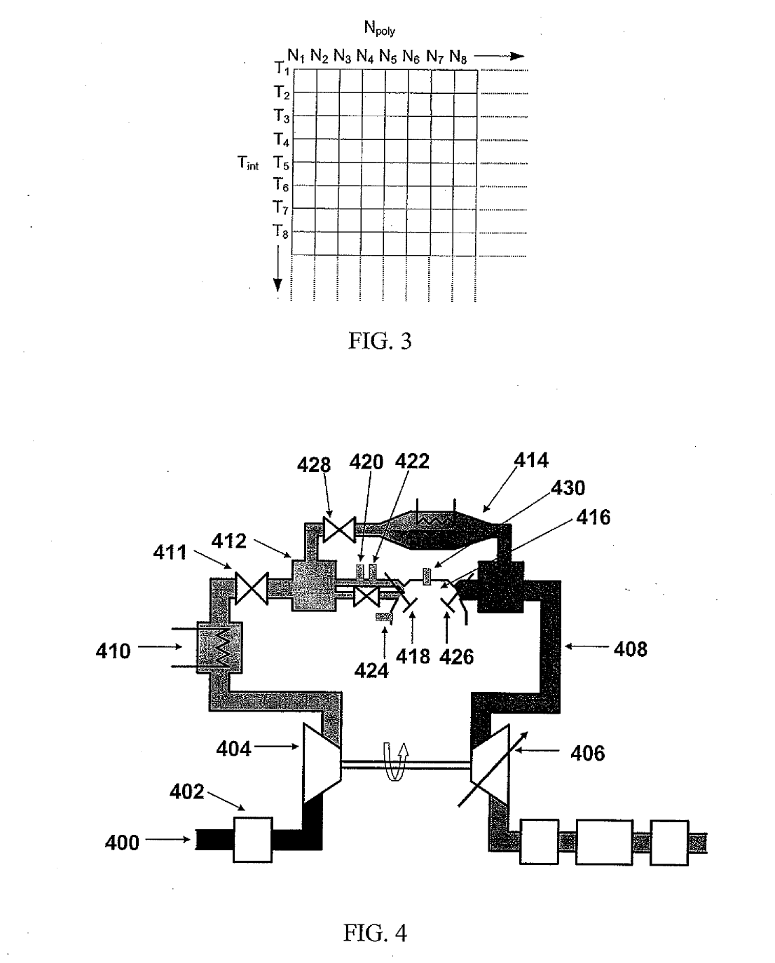

FIG. 3 is a 2-D look-up table giving species concentration Z_{species} as a function of intake temperature (Tᵢₙₜ) and polytropic index (N_{poly});

FIG. 4 shows the a schematic diagram of a diesel engine application;

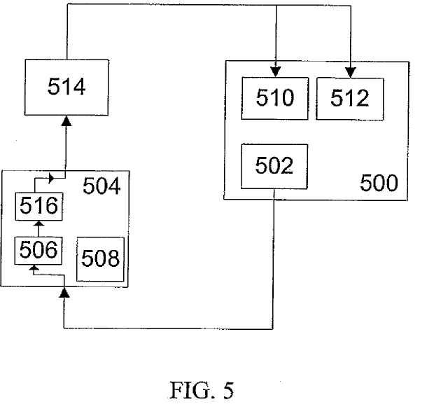

FIG. 5 shows schematically a real-world system flow diagram of an engine utilising closed-loop feedback control.

The invention makes use of the observation that the polytropic index (N_{poly}) of an enclosed gas is closely related to its heat loss and constituent species concentration. For a fully warmed-up engine, this heat loss correlates closely with intake manifold temperature. The steady-state test-bed results of FIGS. 1A and 1B confirm this. FIG. 1A shows charge O₂ concentration plotted against intake manifold temperature and polytropic index estimated over the compression stroke. A model, indicated by the 3D surface, was fitted to these points and is shown in FIG. 1B to agree well with testbed results where the accuracy of the model is depicted by how closely the points are to the 45 degree line. As heat loss can be derived as a function of a sensible value in the form of intake temperature Tᵢₙₜ, and N_{poly} as a function of sensed values of individual cylinder pressure, constituent species concentration can thus be derived per cylinder allowing appropriate correction to be applied subsequently. As discussed in more detail below, the derived values are optimised providing improved accuracy over conventional approaches and the potential for real-time operation.

In a calibration phase, therefore, test-bed results are obtained for each species concentration and plotted against polytropic index and intake manifold temperature. FIG. 2 shows the schematic diagram of a test-bed for obtaining the concentration functions of all species present in a 4-cylinder, 4-stroke engine. Engine block 200 contains four cylinders 202 each with a piston 204, an intake valve 206 and an exhaust valve 208. During the course of normal operation, air 210 enters the system and is mixed with re-circulated exhaust gas 214 by valve 212 operated by controller 216. In-take manifold air temperature is measured by sensor 218 as it passes into one of the four cylinders during the intake stage. In-cylinder pressure is measured by sensors 220 during the compression stroke of engine operation, and together with the data from the in-take temperature sensor, is sent back to ECU 222 and stored in data logger 224. Gas species concentrations are sampled by tapping off some of the intake mixture at the intake ports 225. These can also be compared with excess air ratio (Lambda) measurements from EGO (exhaust gas oxygen) sensors located at the exhaust ports 226. Both sets of data would also be logged by the testbed data acquisition system 227. The polytropic index, N_{poly}, can be calculated directly from the pressure signal and, together with intake manifold temperature, can be implemented in a 2-D lookup table shown in FIG. 3 stored within the ECU of a real-world system, where entries for each of N_{poly} and Tᵢₙₜ are populated to provide:

Z_{X}=f_{X}(N_{Poly},T_{Int}) (1)

where:
Z_{X}=Concentration of species X (air, EGR, O₂, etc) (0-1) as a proportion of total mass M
N_{poly}=Polytropic index at compression (−)
T_{Int}=Intake temperature (K)

It will be seen that the concentration Z_{O2}, Z_{EGR} and so forth can all be obtained in the calibration phase and stored in respective look-up tables. These concentrations can be based on any appropriate parameter such as but not limited to volume or mass. When an engine is running under real-world conditions, and it is desired to obtain Zₓ, calculations take place in two stages. By applying energy balance to the fixed mass of air, fuel and inert gas in the cylinder during the compression stroke before ignition, the derivation of the pressure signal offset and polytropic index is possible. In a first stage, N_{poly} is estimated and Tᵢₙₜ is sampled, preferably local to a cylinder to provide a rough estimation of species concentration Zₓ from the 2-D look-up table derived in the calibration phase as represented by (1). In a second stage, real-time pressure measurements (sensed pressure and a calculated offset) enable the further correction of Zₓ which in turn is used to derive the mass of the particular species present in each cylinder. This information is then fed back to the ECU for subsequent use in controlling variables such as but not limited to the ignition, EGR feedback or fuelling of each individual cylinder.

In the diesel engine shown in FIG. 4, ambient air 400 is channeled through air filter 402, a compressor portion 404 connected to turbine portion 406 of a (preferably variable geometry) turbocharger, intercooler 410, throttle 411 and intake manifold 412. An EGR feedback path 414 allows bulk charge mixing of re-circulated exhaust gas with air within the intake manifold for introduction into each of four cylinders 416 during the intake stage of engine operation when intake valve 418 is open. Pressure sensor 420 and temperature sensor 422 are provided in the in-take manifold and in-cylinder pressure sensor 424 of the type capable of providing real-time samples to the ECU (not shown) is located in each cylinder. The exhaust valve 426 of each cylinder opens into the exhaust system 408 which communicates with EGR feedback path 414 and allows exhaust gas that is not re-circulated to exit preferably via the turbine portion 406 of a (preferably variable geometry) turbocharger.

Intake manifold sensors 420 (pressure) and 422 (temperature) and in-cylinder pressure sensor 424 are arranged to sample data sufficient for the monitoring of charge content per cylinder and hence provide the means with which the ECU obtains Tᵢₙₜ, estimates N_{poly}, obtains Zₓ, further refines Zₓ, and therefore controls EGR valve 428 in order to alter the bulk charge proportion of EGR within the intake manifold 412, inlet valve 418 and exhaust valve 428 in order to alter the individual cylinder charge content, and fuel injector 430 in order to achieve an optimised trade-off between performance, emissions and fuel economy.

Data acquired as set out above is manipulated in real-time to constantly monitor the charge content per cylinder. Stage 1 of this process comprises estimating the polytropic index for a single cylinder:

Applying the polytropic gas law PV^{N}=Const to the cylinder charge gives:

(P_{Sens}+P_{Offset})V_{Cyl}^{N}^{_{Poly}}=K_{Poly}

where:
P_{Sens}=Cylinder pressure measurement (Pa)
P_{Offset}=Sensor offset due to drift (Pa)
V_{Cly}=Cylinder volume (m³)
N_{Poly}=Polytropic index (−)
K_{Poly}=Polytropic constant

Once P_{Offset} is known, the polytropic index may be estimated logarithmically by Linear-Regression taking all samples, preferably more than three, over the compression stroke. However, the direct measurement of P_{Offset} using an intake manifold pressure sensor is not trivial due to pressure fluctuations near IVC (intake valve closure) and sensor noise, and would often lead to errors in the polytropic index. An alternative approach is therefore described below.

The invention herein describes a technique enabling the explicit derivation of N_{Poly} and P_{Offset}.

Turning firstly to N_{Poly}, this can be obtained from a linear expression related to pressure samples taken shortly after IVC up to around 20° before TDC for each cylinder. An accurate TDC point of each cylinder taking into account system delays such as but not limited to thermodynamic loss, processor delays, phase lag of sensors and analogue/digital filters is preferably calibrated on a test-bed at manufacture and is stored as a thermodynamic loss angle and mapped against engine condition. This allows for non-adiabatic thermal loss to the environment and other system delays wherein the peak pressure is non-aligned with the TDC point of the piston within the cylinder which would otherwise create inaccuracies between the timing of the control system and engine cycle/piston position.

Applying energy balance to the trapped mass (in a cylinder) in the continuous time domain gives:

\dot{U}+\dot{W}=\dot{Q} (3)

where \dot{U} is the rate of change of internal energy, \dot{W} is the rate of work done on the environment (heat transfer to the surrounding engine parts) and \dot{Q} is the rate of net heat gained.

The rate of change of internal energy for a gas of fixed mass m at temperature T is given by:

$$\dot{U} = \frac{d}{d t} ( {c}_{v} mT ) \qquad ( 4 )$$

where cᵥ is the specific heat capacity of the gas at constant volume. Applying the perfect gas law PV=mRT gives:

$$\dot{U} = \frac{d}{d t} ( \frac{{c}_{v} PV}{R} ) \qquad ( 5 )$$

where P and V are the pressure and volume of the enclosed gas and R is the gas constant. Since cᵥ/R=1(γ−1), where γ is the ratio of specific heats, and assuming this remains constant, (5) can be rewritten as:

$$\dot{U} = \frac{1}{γ - 1} \frac{d}{d t} ( PV ) \qquad ( 6 )$$

The rate of work done by the gas on the environment is given by:

$$\dot{W} = P \frac{d V}{d t} \qquad ( 7 )$$

Substituting (6) and (7) back into (3) gives:

$$\frac{1}{γ - 1} \frac{d}{d t} ( PV ) + P \frac{d V}{d t} = \dot{Q} \qquad ( 8 )$$

Integrating with respect to time:

$$\frac{1}{γ - 1} {\int }_{{P}_{0} {V}_{0}} d ( PV ) + {\int }_{{V}_{0}} P d V = {\int }_{{t}_{0}} \dot{Q} d t \qquad ( 9 )$$

where suffix ‘0’ denotes initial conditions.

By assuming that the rate of heat exchange is governed by a polytropic gas relationship of polytropic index N_{Poly}, (9) can be approximated to:

$$\frac{1}{{N}_{Poly} - 1} {\int }_{{P}_{0} {V}_{0}} d ( PV ) + {\int }_{{V}_{0}} P d V = 0 \\ or \text{:} \\ \frac{1}{{N}_{Poly} - 1} ( PV - {P}_{0} {V}_{0} ) + {\int }_{{V}_{0}} P d V = 0 \qquad ( 10 )$$

where the left most term includes the heat transfer represented by the closed integral on the right-hand side of (9).

Allowing for inherent errors in sensing the pressure, the sensed pressure P_{Sens} equals actual pressure P modified by an offset P_{Offset}:

P_{Sens}=P−P_{Offset} (11)

hence P=P_{Sens}+P_{Offset}

and assuming the offset remains constant during the compression stroke of the engine, (10) is modified to:

$$\frac{1}{{N}_{Poly} - 1} ( \begin{matrix}{P}_{Sens} V + {P}_{Offset} V - \\ {P}_{{Sens}_{0}} {V}_{0} - {P}_{Offset} {V}_{0}\end{matrix} ) + {\int }_{{V}_{0}} {P}_{Sens} d V + {P}_{Offset} {\int }_{{V}_{0}} d V = 0 \qquad ( 12 )$$

Rearranging this gives:

$$\begin{matrix}\frac{{P}_{Sens} V - {P}_{{Sens}_{0}} {V}_{0}}{{N}_{Poly} - 1} - \frac{{N}_{Poly} {P}_{Offset} ( {V}_{0} - V )}{{N}_{Poly} - 1} + {\int }_{{V}_{0}} {P}_{Sens} d V = 0 \\ or \text{:} & ( 13 ) \\ ( {P}_{Sens} V - {P}_{{Sens}_{0}} {V}_{0} ) {K}_{1} + ( {V}_{0} - V ) {K}_{2} + {\int }_{{V}_{0}} {P}_{Sens} d V = 0 & ( 14 )\end{matrix}$$

where K₁=1/(N_{Poly}−1) and K₂=−N_{Poly}P_{Offset}/(N_{Poly}−1).
over continuous time.

Converting (14) to the discrete crank-synchronous domain and applying trapezoidal integration, for each sample i we can approximate:

XᵢK₁+YᵢK₂=Wᵢ (15)

where:

Xᵢ=P_{Sens}_{ᵢ}Vᵢ−P_{Sens}_{₀}V₀

Yᵢ=V₀−Vᵢ

Wᵢ=Wᵢ₋₁−(P_{Sens}_{_{i−1}}+P_{Sins}_{ᵢ})(Vᵢ−Vᵢ₋₁)/2 (16)

Vᵢ is known at any point as it is directly derivable from the crank (or piston) position and the known volume V₀ of the cylinder, and it can be shown that K₁ and K₂ in (15) can be solved by linear regression (that is to say finding a best solution for the multiple values of Xᵢ, Yᵢ, and Wᵢ) to give numerical values using:

$${K}_{1} = \frac{{\sum }_{i = 1}^{N} {Y}_{i}^{2} {\sum }_{i = 1}^{N} {X}_{i} {W}_{i} - {\sum }_{i = 1}^{N} {X}_{i} {Y}_{i} {\sum }_{i = 1}^{N} {Y}_{i} {W}_{i}}{{\sum }_{i = 1}^{N} {X}_{i}^{2} {\sum }_{i = 1}^{N} {Y}_{i}^{2} - {( {\sum }_{i = 1}^{N} {X}_{i} {Y}_{i} )}^{2}} \\ {K}_{2} = \frac{{\sum }_{i = 1}^{N} {Y}_{i} {W}_{i} - {K}_{1} {\sum }_{i = 1}^{N} {X}_{i} {Y}_{i}}{{\sum }_{i = 1}^{N} {Y}_{i}^{2}} \qquad ( 17 )$$

where Xᵢ, Yᵢ and Wᵢ are calculated at each sample i=1, 2, . . . , N. K₁ and K₂ may be re-arranged from (14) to give:

$${N}_{Poly} = \frac{1}{{K}_{1}} + 1 \qquad ( 18 a )$$

As a result, from measured Tᵢₙₜ and derived N_{Poly}, the corresponding value of Zₓ for that cylinder can be obtained from the look-up table of FIG. 3. In addition, P_{Offset} which can be used in an optimisation as discussed below can be obtained from:

$${P}_{Offset} = \frac{1 - {N}_{Poly}}{{N}_{Poly}} {K}_{2} \qquad ( 18 b )$$

It should be noted that the linear regression proposed its only one method of obtaining a “best fit”. There are many alternative approaches include nonlinear regression, the Maximum Likelihood method and Bayesian Statistics. Iterative approaches would involve constructing a penalty function, E; at each iteration j, such that for example:

$${E}_{j} = {\sum }_{i = 1}^{N} {e}_{i}^{2}$$

where:

eᵢ=XᵢK_{1,j}+YᵢK_{2,j}−Wᵢ

Here K_{1,j} and K_{2,j} are values calculated at each iteration so as to minimise E such that eventually

$$E = \begin{matrix}min \\ {K}_{1} , {K}_{2}\end{matrix} {\sum }_{i = 1}^{N} {e}_{i}^{2}$$

Sufficient convergence will take place after a finite number of iterations and can be achieved using well known minimisation algorithms such as steepest descent and the simplex method. The computational overhead of performing multiple iterations within each engine cycle in any case can be mitigated by spreading the number of iterations over multiple cycles such that after, say, 3 iterations in one cycle the calculated values of K₁ and K₂ can be carried over to the next. Convergence will therefore take place after a number of engine cycles. The maximum number of iterations per cycle is selected to ensure overall convergence takes place, especially during transients.

Stage 2 of the process comprises obtaining an estimate of Zₓ. Depending on the specification of the pressure sensors in use, one of two methods may be employed to execute stage 2. By way of explanation, the following example relates to Z_{O2} using the fact that additional information is available in the form of the oxygen mass in the in-take manifold (26). Method A estimates the distribution of cylinder O₂ concentration assuming that the mass is the same in each cylinder and method B provides an improved estimate of the distribution of O₂ concentration and, in addition, estimates the respective masses. The difference in intake temperature of the inducted mixture between cylinders is assumed to be small relative to absolute temperatures.

### Method A: Improved Estimation of Cylinder O₂ Concentration Distribution

A first estimate of the cylinder O₂ concentration is obtained as described above from (1):

Z_{O2indi}*=f_{O2}(N_{Polyi},T_{Int}) (19)

where:
Z_{O2indi}*=First estimate of O₂ concentration in cylinder i (0-1)
N_{Polyi}=Polytropic index of cylinder i (−)
f_{O2}=O₂ concentration function (may be implemented as a 2-D lookup table as described above)
T_{Int}=Intake manifold temperature (K)

The intake manifold temperature is assumed to be the same for all cylinders.

This first estimate obtained is an empirical value from the test-bed model calibrated look-up table of FIG. 3. The individual cylinder concentrations are corrected for mass balance from knowledge of the O₂ concentration in the intake manifold. A common proportional correction factor, α, is applied, defined by:

Z_{O2Indi}=αZ_{O2Indi}* (20)

where Z_{O2Indi} is the corrected oxygen concentration for cylinder i.

The mass balance relationship is as follows:

$${M}_{O 2 Int} = {\sum }_{i = 1}^{4} {M}_{O 2 Indi} \qquad ( 21 )$$

where M_{O2Int} is the oxygen intake manifold mass per cycle and M_{O2Indi} is the inducted oxygen mass for cylinder i of a 4-cylinder engine. This can be re-expressed as functions of oxygen concentrations and total inducted masses as

$${Z}_{O 2 Int} = \frac{{M}_{O 2 Int}}{{M}_{Int}} and {Z}_{O 2 Indi} = \frac{{M}_{O 2 Indi}}{{M}_{Indi}} , \\ giving \text{:} \\ {Z}_{O 2 Int} {M}_{Int} = {\sum }_{i = 1}^{4} {Z}_{O 2 Indi} {M}_{Indi} \qquad ( 22 )$$

Applying (20) and re-arranging gives:

$$α = \frac{{Z}_{O 2 Int} {M}_{Int}}{{\sum }_{i = 1}^{4} {Z}_{O 2 Indi}^{*} {M}_{Indi}} \qquad ( 23 )$$

This gives the following for cylinder i:

$${Z}_{O 2 Indi} = \frac{{Z}_{O 2 Int} {M}_{Int}}{{\sum }_{i = 1}^{4} {Z}_{O 2 Indj}^{*} {M}_{Indj}} {Z}_{O 2 Indi}^{*} \\ where j = 1 , 2 , 3 , 4. \qquad ( 24 )$$

By assuming the difference in total trapped charge masses between cylinders is small, the M's cancel due to

$${M}_{Int} = {\sum }_{j = 1}^{4} {M}_{Indj}$$

leaving:

$${Z}_{O 2 Indi} = \frac{{Z}_{O 2 Int}}{{\sum }_{j = 1}^{4} {Z}_{O 2 Indj}^{*}} {Z}_{O 2 Indi}^{*} \qquad ( 25 )$$

where:
Z_{O2Ind}=Corrected concentration of inducted cylinder O2 (0-1), based on the average O2 concentration obtained from mean-value observer models.
Z_{O2int}=Bulk O2 concentration in the intake manifold (0-1)

This results in correctional factor

$$α = \frac{{Z}_{O 2 Int}}{{\sum }_{i = 1}^{4} {Z}_{O 2 Indj}^{*}} ,$$

effectively related to how close the sum of the concentrations Z_{O2Indj}* is to the expected value Z_{O2Int}. If the summed first estimates of Z_{O2Indj}* are less than Z_{O2Int}, the correctional factor increases the original estimate of Z_{O2Indi}*, and if they are more, the factor decreases the original estimate.

The bulk O₂ concentration Z_{O2Int} can be approximated by the following known steady-state expression that applies to lean mixtures:

Z_{O2Int}=Z_{O2Atm}(1−Z_{EGR}/λ) (26)

where:
Z_{O2Atm}=Ambient O₂ concentration (0.23 as standard based on mass) (0-1)
Z_{EGR}=EGR rate (0-1)
λ=Excess air ratio (−)=AFR/stoichiometricAFR

Known observer models such as mean-value models in some of today's ECUs can be applied to obtain Z_{EGR}. The excess air ratio, λ, can be obtained from an EGO sensor.

In equations (15-18), polytropic index N_{Poly} was found from sensed pressure reading P_{Sens}_{ᵢ}, without requiring an absolute pressure reading taking sensor gain or offset into account. Species concentration equation (25) holds true as long as the pressure sensor returns a reading proportional to the true reading, irrespective of the offset. In addition, the cylinder pressure is immune to hysteresis as it is monotonic with crank angle over the compression stroke.

### Method B: Improved Estimation of O₂ Concentration and Mass Distribution

According to the invention, a further complementary, more precise correction may be applied to the O₂ concentration obtained from method A that additionally takes into consideration the differences in total charge masses between cylinders i.e. without the assumption on which (25) is based.

Using (24):

$${Z}_{O 2 Indi} = \frac{{Z}_{O 2 Int} {M}_{Int}}{{\sum }_{j = 1}^{4} {Z}_{O 2 Indj}^{*} {M}_{Indj}} {Z}_{O 2 Indi}^{*}$$

where:
M_{Int}=Total intake mass per engine cycle (sum of all cylinders) (kg)
M_{Indj}=Total inducted mass in cylinder j (kg)

The O₂ mass is given by:

$$\begin{matrix}{M}_{O 2 Indi} = {Z}_{O 2 Indi} {M}_{Indi} \\ = \frac{{Z}_{O 2 Int} {M}_{Int}}{{\sum }_{j = 1}^{4} {Z}_{O 2 Indj}^{*} {M}_{Indj}} {Z}_{O 2 Indi}^{*} {M}_{Indi}\end{matrix} \qquad ( 27 )$$

where the bulk estimate, M_{Int}, is obtained from known observer models in today's ECUs.

The individual cylinder masses are obtained directly from the cylinder pressure sensors as follows:

The inducted mass of cylinder i can be expressed as:

$${M}_{Indi} = {η}_{Voli} \frac{{P}_{Int}}{{RT}_{Int}} {V}_{CylDisp} \qquad ( 28 )$$

where:
η_{Voli}=Volumetric efficiency of cylinder i (0-1)
P_{Int}=Intake manifold pressure (Pa)
R=Gas constant (J/kg/K)
T_{Int}=Intake temperature (K)
V_{CylDisp}=Cylinder displacement volume (m³)

Note that P_{Int} and T_{Int} are assumed to be the same for all cylinders and the variation of R with gas properties is assumed to be negligible.

It can be shown for example in Taylor, C., The Internal Combustion Engine in Theory and Practice, Volume 1, MIT Press, 1985 that by assuming the valve overlap period is negligible the volumetric efficiency can be estimated directly from cylinder pressure thus:

$${η}_{Voli} = \frac{1}{{P}_{Int} {V}_{CylDisp} ( 1 + Δ {T}_{i} / {T}_{Int} )} [ \begin{matrix}\frac{γ - 1}{γ} {\int }_{IVO}^{IVC} {P}_{Cyli} d {V}_{Cyl} + \\ \frac{\begin{matrix}{P}_{IVCi} {V}_{IVC} {C}_{CompRat} - \\ {P}_{IVOi} {V}_{CyIDsip}\end{matrix}}{γ ( {C}_{CompRat} - 1 )}\end{matrix} ] \qquad ( 29 )$$

where:
V_{CylDisp}=Cylinder displacement volume (m³)
V_{Cyl}=Cylinder volume (m³)
V_{IVC}=Cylinder volume at IVC (m³)
C_{CompRat}=Compression ratio (−)
P_{Cyli}=Cylinder i pressure (Pa)
P_{IVOi}=Cylinder i pressure at intake valve open (IVO) (Pa)
P_{IVCi}=Cylinder i pressure at IVC (Pa)
γ=Ratio of specific heats (−)
ΔTᵢ=Temperature increase from in-take manifold to cylinder

$${\int }_{IVO}^{IVC} {P}_{Cyli} d {V}_{Cyl} = work done on cylinder during induction$$

Substituting (29) for η_{Voli} in (28) results in the cancellation of P_{Int} and V_{CylDisp} thus:

$$\begin{matrix}{M}_{Indi} = \frac{{μ}_{Voli}}{R ( {T}_{Int} + Δ {T}_{i} )} \\ where & ( 30 ) \\ {μ}_{Voli} = \frac{γ - 1}{γ} {\int }_{IVO}^{IVC} {P}_{Cyli} d {V}_{Cyl} + \frac{\begin{matrix}{P}_{IVCi} {V}_{IVC} {C}_{CompRat} - \\ {P}_{IVOi} {V}_{CylDisp}\end{matrix}}{γ ( {C}_{CompRat} - 1 )} & ( 31 )\end{matrix}$$

The cylinder pressures are corrected by;

P_{Cylj}=P_{Sensj}+P_{Offset}, j=IVO, . . . , IVC

where P_{offset} is obtained from Stage 1.

Alternatively, this can be pegged to intake manifold pressure, P_{Int}, ie:

P_{Cyl}=P_{Sens}+P_{Offset}−P_{IVCLR}+P_{Int}

where P_{IVCLR} is the first estimate of IVC pressure taken from the linear regression fit in Stage 1.

Applying (30) to (27), the cylinder O₂ mass is now given by:

$${M}_{O 2 Indi} = \frac{{Z}_{O 2 Int} {M}_{Int}}{{\sum }_{j = 1}^{4} {Z}_{O 2 Indj}^{*} \frac{{μ}_{Volj}}{R ( {T}_{Int} + Δ {T}_{j} )}} {Z}_{O 2 Indi}^{*} \frac{{μ}_{Voli}}{R ( {T}_{Int} + Δ {T}_{i} )} \qquad ( 32 )$$

If the intake temperature sensor is located midway between the intake ports of all cylinders, any differences in ΔTᵢ, (i=1, . . . , 4) can be assumed small compared to Tᵢₙₜ. This important assumption results in the following solution for inducted O₂ mass, M_{O2Indi}, for cylinder i:

$${M}_{O 2 Indi} = {Z}_{O 2 Int} {M}_{Int} \frac{{Z}_{O 2 Indi}^{*} {μ}_{Voli}}{{\sum }_{j = 1}^{4} {Z}_{O 2 Indj}^{*} {μ}_{Volj}} \qquad ( 33 )$$

where the bulk estimate, M_{Int}, is obtained from known observer models found in some of today's ECUs. All other variables are either known or measurable as described herein.

Unlike Method A, this method requires gain calibration of the cylinder pressure sensor as the absolute pressure is required, derived from the sensed value and the offset as found in stage 1.

It should be appreciated that while the above methods employ multiplicative corrections to a first estimate, Z_{O2Indi}*, additive corrections to equations (24) and (25) such as but not limited to

$${Z}_{O 2 Indi} = {Z}_{O 2 Indi}^{*} + δ$$

$$where$$

$$δ = {Z}_{O 2 Int} - \frac{{\sum }_{i = 1}^{4} {Z}_{O 2 Indi}^{*} {M}_{Indi}}{{\sum }_{i = 1}^{4} {M}_{Indi}}$$

would be equally valid.

Furthermore, it should be understood that the concentration of other species present may be estimated using the same principle as the O2 estimation described in stage 2 above.

When performing calculations with instantaneous cylinder pressures and volumes, such as in (16), (29) and (31), it is preferred that the crank angles for pressure and volume match as closely as possible such that the pressure is known fairly accurately at each position of the crankshaft. As discussed above, the accuracy depends on knowing precisely where the TDC occurs in the pressure trace. In practice there is a small but noticeable offset between the TDC as “seen” by the ECU and its true location due to crank sensor offset.

Furthermore, this can be slightly different for each cylinder due to crank pin offset of each piston and even crankshaft flexibility. For the control system described herein, a further apparent offset can occur due to the measuring chain delay such as sensor response time, phase lag in the filtering of raw pressure signals, signal acquisition delay and a further effect to be accounted for is the thermodynamic loss angle. In an ideal case where there is no heat transfer between the enclosed gas mixture and the cylinder walls (ie. adiabatic compression), the maximum pressure would occur at TDC. In practice, because of heat transfer, this maximum will always occur before TDC by an amount called the thermodynamic loss angle. This angle varies with engine speed and wall temperature, the latter of which can result in a noticeable difference between cylinders. A further correction is therefore necessary to the TDC 115 position to accommodate for this effect. The total correction is therefore given by:

Δθ_{Offset}=θ_{Pmax}+Δθ_{TLA}−Δθ_{MC}

where:
Δθ_{Offset}=TDC offset angle
θ_{Pmax}=Angle of maximum pressure measured during overrun or late injection
Δθ_{TLA}=Thermodynamic loss angle
Δθ_{MC}=Measuring chain delay angle

If, at pressure sample i, the corresponding crank-angle is taken to be θᵢ, then for all angles, i=1 to N, the following correction will need to be applied:

θ_{i,k}=θ_{i,k-1}−βΔθ_{Offset,k}

where Δθ_{Offset,k} is the TDC offset calculated in the k^{th} engine cycle and β is a tuning constant less than 1 to ensure these corrections occur gradually.

FIG. 5 shows a real-world system control diagram of an engine utilising closed-loop feedback control such as but not limited to the engine shown in FIG. 4. When Engine 500 is operational, sensors 502 constantly monitor in real-time, data such as but not limited to intake manifold pressure and temperature, and individual in-cylinder pressure. ECU 504 receives the sensor data. Stage 1 (506) of the method comprises estimating the polytropic index. Stage 2 (516) comprises obtaining from a look-up table 508, a first estimate Z; of the concentration of a particular gas species such as but not limited to air, O₂ or EGR present within an individual cylinder. The empirical first estimate (equation 19) of individual cylinder O₂ concentration is preferably corrected for mass balance (equations 24 and 25). This species concentration data, corrected as appropriate, may be used to control fuel injectors 510 and/or EGR valve 512 with controller 514 in order to attain desired effects such as but not limited to reduced emissions and/or increased fuel economy. If the i-cylinder pressure sensors are of a suitable specification, stage 2 (516) Method B is preferably employed subsequent to stage 1 wherein the mass of a species present within an individual cylinder may be calculated (equation 33 with 30) to further enhance the quality of the controlling data obtained from stage 1.

It will be seen that the invention as described provides a range of solutions to common engine problems. The measurement of parameters such as but not limited to volume and pressure of the gas species present within each individual cylinder provides data that, together with the methodologies described in stages 1 and 2 of the invention, allow increased control of engine parameters on a species by species and cylinder by cylinder basis, including where required, an accurate value of P_{Offset} derived by linear regression. Variables such as proportion of EGR within any one cylinder at any one time provide the advantage of reduced emissions particularly in the case of a diesel engine. Improved fuelling allows optimum AFR or O₂/fuel ratio leading to increased fuel economy and in the case of diesel engines, reduced particulate content of the exhaust gas leading to the avoidance of expensive add-on cleaning systems in order to meet emissions regulations. Control can be in any appropriate manner for example EGR control by variable valve actuation (VVA).

A further advantage of the individual cylinder approach is the avoidance of one “culprit” cylinder affecting the control of variables such as fuelling, ignition, EGR, and air content of every other cylinder in the same way.

It should be appreciated that the two stage method herein described of identifying engine gas composition may equally be applied to other engine configurations and types such as but not limited to differing engine types, such as rotary, differing stroke cycles and differing number of cylinders employed, and differing fuel types, such as diesel or gasoline, wherein the ignition may additionally be controlled as a result of the data obtained.

It should be further appreciated that, as well as direct sensing of in-cylinder pressure, the pressure sensor can be mounted external to the cylinder, in the form of a spark-plug washer, gasket displacement sensor or integrated into a glow-plug.

1. A method of identifying engine gas composition in an engine cylinder comprising obtaining a measure of cylinder pressure from a cylinder pressure sensor, deriving a polytropic index from said measure and obtaining a measure of the quantity of an engine gas component therefrom.

2. The method as claimed in claim 1 further comprising obtaining a measure of heat loss and obtaining the measure of quantity of engine gas component from the heat loss and polytropic index.

3. The method as claimed in claim 2 in which the measure of heat loss comprises the engine intake temperature.

4. The method as claimed in claim 1 in which the measure of quantity of engine gas component comprises component concentration.

5. The method as claimed in claim 4 in which the concentration comprises one of a mass or volume ratio.

6. The method as claimed in claim 1 in which the measure of quantity of engine gas component is obtained from a look-up table.

7. The method as claimed in claim 1 in which an engine has multiple cylinders and the measure of quantity of an engine gas component is obtained for each cylinder.

8. The method as claimed in claim 1 in which the polytropic index is obtained from (P_{Sens}−P_{Offset})V_{Cyl}^{N}^{_{Poly}}=K_{Poly} over a range of samples of P_{Sens} and V_{Cyl}.

9. The method as claimed in claim 1 in which the polytropic index is estimated directly in one iteration.

10. The method as claimed in claim 1 in which the polytropic index is estimated iteratively using a minimisation technique.

11. The method as claimed in claim 8 in which multiple cylinder pressure sensor values are obtained per engine cycle and the measure of quantity of engine gas component is obtained by linear regression from the multiple values.

12. The method as claimed in claim 1 in which cylinder pressure sensor values are obtained over a single engine cycle.

13. The method as claimed in claim 1 in which the cylinder pressure sensor values are obtained over multiple cycles.

14. The method as claimed in claim 1 in which the cylinder pressure sensor values are uncorrected before applying an offset.

15. The method as claimed in claim 1 in which the engine gas component comprises at least one of O₂, air, recirculated exhaust gas, and combinations thereof.

16. The method as claimed in claim 1 further comprising controlling engine intake gas based on said measured quantity of engine gas component to vary said measure.

17. The method as claimed in claim 16 in which the engine intake gas is controlled by controlling intake recirculated exhaust gas.

18. The method as claimed in claim 16 further comprising controlling engine intake gas by controlling bulk charge content via an EGR valve, throttle, variable geometry turbocharger, variable geometry compressor or any other such means.

19. The method as claimed in claim 1 further comprising controlling engine intake gas by controlling individual cylinder charge content by inlet and/or exhaust port valves or throttles or any other such means.

20. The method as claimed in claim 1 in which the engine gas component comprises O₂ and, for multiple engine cylinders, the measure is corrected from a comparison of the sum of the measures for each cylinder against a derived bulk O₂ intake value.

21. The method as claimed in claim 20 in which the measure of quantity of O₂ is further corrected by comparison with a measure of individual cylinder O₂ mass.

22. The method as claimed in claim 21 in which the measure of individual cylinder O₂ mass is derived from a measure of cylinder pressure.

23. The method as claimed in claim 22 in which the measure of cylinder pressure is obtained as a function of the sensed pressure and an offset pressure.

24. The method as claimed in claim 22 in which the offset pressure is obtained as a function of the polytropic index.

25. The method as claimed in claim 1 in which the measure of quantity of engine gas component for a value of polytropic index is obtained in a calibration phase.

26. A method of obtaining polytropic index of a gas in an engine cylinder comprising obtaining a measure of the cylinder pressure from a cylinder pressure sensor and obtaining a polytropic index from a method as claimed in any preceding claim in which the polytropic index is obtained from (P_{Sens}−P_{Offset})V_{Cyl}^{N}^{_{Poly}}=K_{Poly}, in which multiple cylinder pressure sensor values are obtained and linear regression is applied.

27. A method of obtaining cylinder pressure sensor offset in an engine cylinder, comprising obtaining a measure of cylinder pressure from a cylinder pressure sensor, deriving the polytropic index, the deriving comprising obtaining a measure of cylinder pressure from a cylinder pressure sensor, obtaining a measure of the quantity of an engine gas component therefrom in which the measure of quantity of engine gas component for a value of polytropic index is obtained in a calibration phase, and deriving the offset pressure as a function of the polytropic index.

28. A method of identifying piston top dead centre (TDC) in an engine cylinder as a function of pressure sensed at a cylinder pressure sensor comprising in a calibration phase, identifying piston top dead centre, estimating maximum pressure from sensed pressure, identifying the offset between TDC and maximum pressure and storing the offset as a function of engine condition.

29. The method as claimed in claim 27 in which the offset is stored as a function of one of per cylinder engine condition or global engine condition.

30. The method as claimed in claim 28 in which the engine condition comprises one of polytropic index or a measure of heat loss.

31. A method of correcting piston top dead centre in an engine cylinder comprising obtaining an offset angle between true TDC and the angle at maximum sensed pressure and applying the offset to angles at which the pressure is sensed.

32. An apparatus for identifying engine gas composition in an engine cylinder comprising a cylinder pressure sensor arranged to obtain a measure of cylinder pressure and a processor arranged to derive the polytropic index from said measure and obtain a measure of quantity of an engine gas component therefrom.

33. An apparatus for controlling engine gas composition comprising an apparatus for identifying engine gas composition as claimed in claim 32 and at least one actuator actuatable under the control of the processor to vary the composition of intake gas.

34. The method as claimed in claim 33 in which the actuator is arranged to control bulk engine intake gas.

35. The apparatus as claimed in claim 33 in which the actuator comprises one of an EGR valve, throttle, variable geometry turbocharger, variable geometry compressor or any other such actuator.

36. The apparatus as claimed in claim 33 in which the actuator is arranged to control cylinder intake gas.

37. The apparatus as claimed in claim 35 in which the actuator comprises one of an inlet and/or an exhaust port valve or throttle or any other such actuator.

38. (canceled)

39. (canceled)
